(19) United States
(12) Patent Application Publication
(10) Pub. No.: US 2007/0146519 A1
(43) Pub. Date: Jun. 28, 2007

(54) Imaging device

(76) Inventor: Takahiro Iwasawa, Kyoto (JP)

Correspondence Address: MCDERMOTT WILL & EMERY LLP, 600 13TH STREET, N.W., WASHINGTON, DC, 20005-3096, US

(21) Appl. No.: 11/642,782

(22) Filed: Dec. 21, 2006

(30) Foreign Application Priority Data
Dec. 27, 2005 (JP) 2005-374030

(51) Int. Cl. H04N 5/335

(52) U.S. Cl. 348/308

(57) ABSTRACT

Plural pixel cells generate electric charge signals through photoelectric conversion and then accumulate the electric charge signals therein. An adjustment pixel signal generating part generates differences between the first output voltages of the pixel cells where a prescribed voltage is applied and accumulated and the second output voltages of the pixel cells where the electric charge signals are accumulated, as the adjustment pixel signals. The amplitude detection part detects amplitudes of the adjustment pixel signals. The initialization level adjusting part adjusts an initialization level of the prescribed voltage in accordance with the result of amplitude detection performed by the amplitude detection part.

### BACKGROUND OF THE INVENTION

1. Field of the Invention

The present invention relates to an imaging device using solid-state image pickup device and, more specifically, to a technique that maximizes saturating amplitudes of pixel signals through absorbing variations in transistor properties due to individual differences among a plurality of imaging devices.

2. Description of the Related Art

An MOS type constituted with three transistors (a reset gate, a transfer gate, an output transistor) per pixel cell, has been conventionally used as a solid-state image pickup element, (for example, see Japanese Published Patent Literature: Japanese Unexamined Patent Publication 2003-46864).

Incidentally, it is inevitable that variation in the transistor property is generated between a plurality of imaging devices due to their individual differences. In the conventional techniques, the common power supply voltage at a low level is always fixed to a constant value. Thus, the amount of the electric charges held in an electric charge accumulating part FD also varies due to the variation in the transistor property. As a result, the maximum amplitude of the pixel signals may not be obtained depending on the transistor property of the imaging device.

### SUMMARY OF THE INVENTION

The main object of the present invention therefore is to optimize the amount of electric charges held in the electric charge accumulating part so as to enable any kinds of imaging devices to obtain the pixel signals of the maximum amplitude.

In order to achieve the aforementioned object, an imaging device according to the present invention comprises

a plurality of pixel cells which generate electric charge signals by photoelectric conversion and accumulate the electric charge signals,

an adjustment pixel signal generating part for generating adjustment pixel signals based on the electric charge signals,

an amplitude detection part, and

an initialization level adjusting part, wherein:

the adjustment pixel signal generating part generates difference between first output voltages of the pixel cells where a prescribed voltage is applied and accumulated, and second output voltages of the pixel cells where the electric charge signals are accumulated, as the adjustment pixel signals;

the amplitude detection part detects amplitudes of the adjustment pixel signals; and

the initialization level adjusting part adjusts an initialization level of the prescribed voltage in accordance with a result of amplitude detection performed by the amplitude detection part.

It is preferable that the pixel cells are arranged in matrix to constitute a pixel cell array;

the imaging device further comprise a row scanning part which selects a group of pixel cells of one row in the pixel cell array in order by a row unit; and

the adjustment pixel signal generating part generate the adjustment pixel signals by a unit of the group of pixels in one row that is selected by the row scanning part.

Further, it is preferable that the pixel cells comprise, respectively:

a photoelectric conversion element for generating the electric charge signals by photoelectric conversion;

an electric charge accumulating part for accumulating the electric charge signals;

a reset gate for performing a supply control of the prescribed voltage to the electric charge accumulating pat;

a transfer gate for performing a supply control of the electric charge signals to the electric charge accumulating part; and

an output transistor whose output voltage is adjusted in accordance with a voltage accumulated in the electric charge accumulating part, wherein:

the first output voltages are output voltages of the output transistor under a state where the prescribed voltage is applied to the electric charge accumulating part by cutting off the transfer gate and electrically connecting the reset gate; and

the second output voltages are output voltages of the output transistor under a state where the electric charge signals are transferred to the electric charge accumulating part by cutting off the reset gate and electrically connecting the transfer gate.

Furthermore, it is preferable that the adjustment pixel signal generating part set the common power supply voltage to an initialization level and set the output transistor to be under an unselected state in a horizontal blanking period.

Moreover, it is preferable that the reset gate is connected electrically through the adjustment pixel signal generating part so as to set the output transistor to be under an unselected state.

In this structure, the row scanning part selects the group of pixel cells of one row in the pixel cell array in order by a row unit. The adjustment pixel signal generating part applies the prescribed voltage to the electric charge accumulating part under a state where the reset gats is electrically connected in the group of pixel cells of the selected one row, and clamps the output voltage outputted from the output transistor in that state as the first output voltage. Then, under the state where the reset gate is cut off and the transfer gate is electrically connected, the adjustment pixel signal generating part transfers the electric charge signal from the photoelectrical conversion element to the electric charge accumulating part, and samples and holds the output voltage outputted from the output transistor in that state as the second output voltage. Then, the adjustment pixel signal generating part generates the difference between the first and second output voltages as the adjustment pixel signal.

The amplitude detection part detects the amplitude of the adjustment pixel signal, and the initialization level adjusting part adjusts the initialization level of the prescribed voltage according to the result of amplitude detection. In a horizontal blanking period, the adjustment pixel signal generating part sets the common power supply voltage to the initialization level and sets the output transistor to be under an unselected state. The initialization level of the prescribed voltage at that time is set by the initialization level adjusting part in advance according to the detected amplitude of the adjustment pixel signal.

Based on the initialization level of the prescribed voltage that is initialized in this manner, the electric potential level is adjusted to the “L”-level common power supply voltage every time a group of pixels cells of one row is selected. Thus, the amount of electric charges held in the electric charge accumulating part is optimized.

Therefore, it is possible to maximize the saturating amplitudes of the pixel signals in any kinds of imaging devices through optimizing the amount of the electric charges held in the electric charge accumulating part even if there is variation in the transistor property among a plurality of imaging devices due to the individual difference.

In the above-described structure, it is preferable that the initialization level adjusting part adjusts the initialization level of the prescribed voltage so that amplitudes of the adjustment pixel signals become the maximum. With this, the saturating amplitudes of the pixel signals can be maximized in any kinds of imaging devices.

Further, it is preferable that the amplitude detection part detect amplitudes of the adjustment pixel signals before picking up images, and the initialization level adjusting part adjust the initialization level of the prescribed voltage before picking up images. By doing so, the saturating amplitudes of the pixel signals can be adjusted without affecting the actual filming.

Furthermore, it is preferable that the imaging device further comprise, separately from the pixel cells, dummy pixel cells having an electric charge accumulating part that is always under an unselected state during an action of picking up images, wherein

the adjustment pixel signal generating part generates difference between first output voltages of the dummy pixel cells where a prescribed voltage is applied and accumulated and second output voltages of the dummy pixel cells where the electric charge signals are accumulated, as the adjustment pixel signals.

By doing so, the amount of the electric charges held in the electric charge accumulating part can be optimized by following the changes in the environmental conditions such as temperature and power supply voltage.

According to the present invention, the initialization level of the prescribed voltage is adjusted in accordance with the amplitude of the adjustment pixel signal. Thus, the amount of the electric charges held in the electric charge accumulating part can be optimized even if there is variation in the transistor property between a plurality of imaging devices due to the individual difference. Therefore, it is possible to maximize the saturating amplitudes of the pixel signals in any kinds of imaging devices. As a result, the standard gain of the imaging element can be decreased so as to improve the S/N ratio of the video signals.

The imaging device of the present invention is capable of obtaining the maximum saturating signal output regardless of the individual differences among the solid-state imaging elements, and it is effective as an application of cameras such as mobile camera, camcorder, surveillance camera.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a block diagram showing the structure of an imaging device according to an embodiment of the present invention;

FIG. 2 is a circuit block diagram showing a specific structure of a solid-state imaging element according to the embodiment of the present invention;

FIG. 3 is a circuit diagram showing the structure of a pixel cell according to the embodiment of the present invention;

FIG. 4 is a timing chart showing the action of the imaging device according to the embodiment of the present invention;

FIG. 5A-FIG. 5G are illustrations of changes in electric potentials showing the action according to the embodiment of the present invention at the time of reading out the adjustment pixel signals of the pixel cell in of the imaging device;

FIG. 6 is a circuit diagram showing the structure of the pixel cell; and

FIG. 7A-FIG. 7G are illustration of changes in electric potentials showing the action at the time of reading out the adjustment pixels signals of the pixel cell in the imaging device.

### DETAILED DESCRIPTION OF THE INVENTION

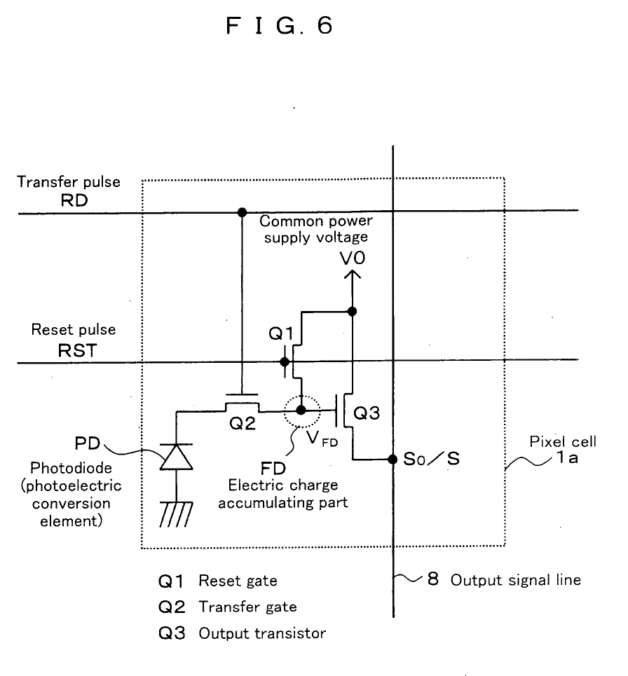

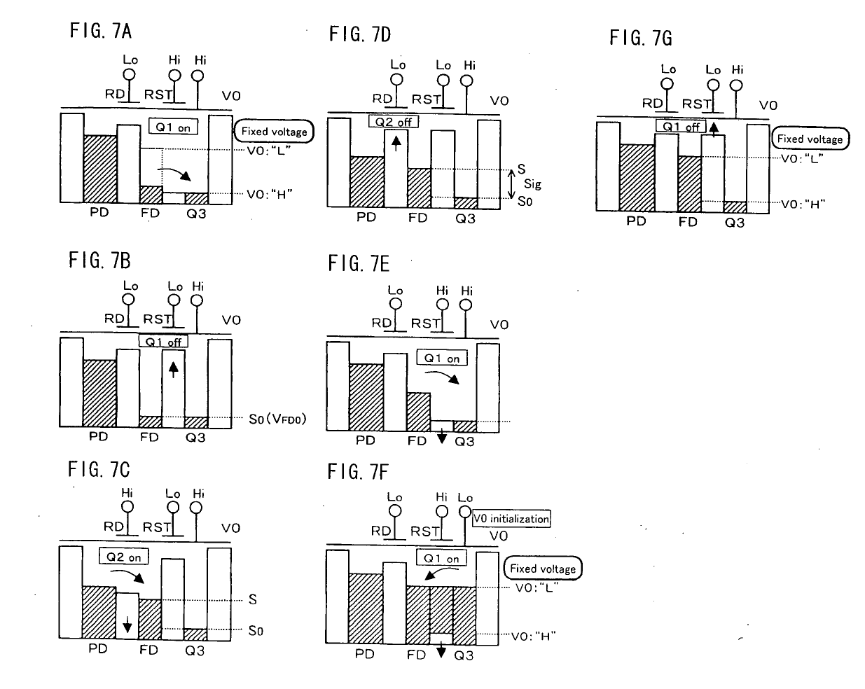

First, the fundamental structure (structure of pixel cell 1a) and the fundamental action of an imaging device by which the present invention is embodied, will be described referring to the circuit diagram of FIG. 6 and illustrations of the electric potential changes shown in FIG. 7A-FIG. 7G. It is assumed here that a transfer gate Q is in an off-state and electrons in accordance with the received light amount are being accumulated in a photodiode PD. When a reset gate Q1 is turned on by a reset pulse RST, an “H”-level common power supply voltage V0 is applied to an electric charge accumulating part FD and the accumulated electric charge (minus) in the electric charge accumulating part FD is reset (see FIG. 7A). The voltage V_{FD} in the electric charge accumulating part FD at this time is the reference potential V_{FD0}. In an output transistor Q3, a first output voltage S₀ in accordance with the reference potential V_{FD0} is outputted to a noise cancel circuit (not shown) from an output signal line 8. Then, the reset gate Q1 is set off (see FIG. 7B). The first output voltage S₀ is clamped in the noise cancel circuit.

Meanwhile, the photodiode PD accumulates the electric charges (electrons) in accordance with the received light amount during the period where the transfer gate Q2 is off. When the transfer gate Q2 is turned on, the accumulated electric charges in the photodiode PD flow in the electric charge accumulating part FD. Thus, the voltage V_{FD} in the electric charge accumulating part FD drops to the amount of flown electric charges (see FIG. 7C). As a result, the output voltage S outputted from the transistor Q3 to the noise cancel circuit via the output signal line 8 drops as well. This output voltage S is sampled and held in the noise cancel circuit. Then, the transfer gate Q2 is set off, and the photodiode PD restarts the accumulating action of the electrons in accordance with the received light amount (see FIG. 7D). The noise cancel circuit calculates the difference in the electric potentials between the above-described two points as an adjustment pixel signal Sig (=S₀−S). In this adjustment pixel signal Sig, variations in the threshold values of the output transistor Q3 and the noise component thereof are cancelled.

Then, the common power supply voltage V0 is set to “L”-level by initialization and the reset gate Q1 is turned on again, so that the output transistor Q3 is set off and the pixel cell 1a shifts to an unselected state (see FIG. 7E and FIG. 7F). At last, the reset gate Q1 is turned off (see FIG. 7G). When the pixel cell 1a is selected again, the action is restarted from the state shown in FIG. 7.

In this structure, the “L”-level is uniformly fixed as a constant voltage in the conversion processing of the common power supply voltage V0 to the “L”-level to make the pixel cell 1a under an unselected state. In FIG. 7A, this common power supply voltage V0 is applied to the electric charge accumulating part FD when the reset gate Q1 is turned on, which serves as a reference for forming the reference potential V_{FD0}. The reference potential V_{FD0} of the electric charge accumulating part FD serves as the reference for determining the amount of the electric charges held in the electric charge accumulating part FD on and after.

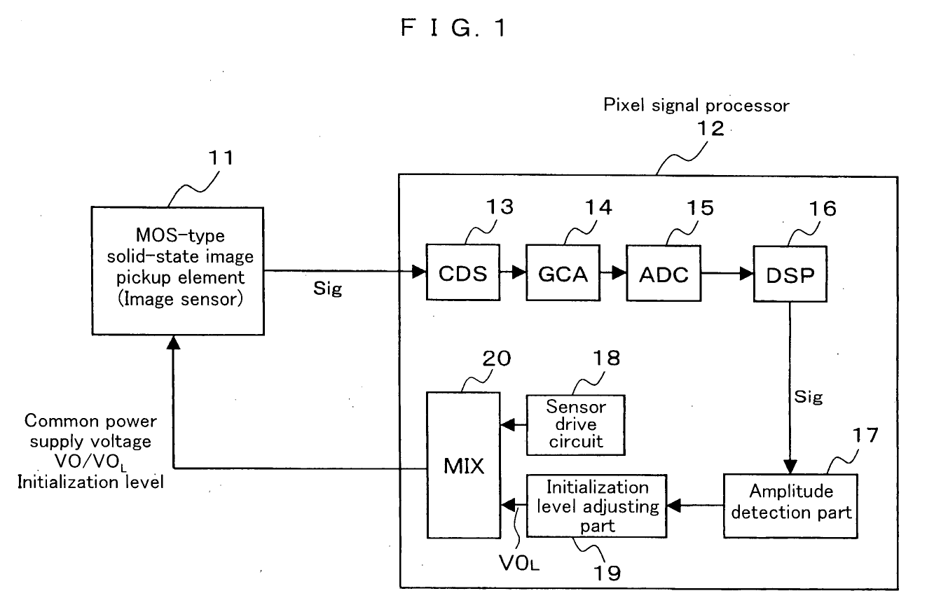

Hereinafter, a preferred embodiment of the present invention will be described referring to the accompanying drawings. FIG. 1 is a block diagram showing the structure of the imaging device according to the embodiment of the present invention. In FIG. 1, reference numeral 11 is an MOS-type solid-state image pickup element (image sensor), and 12 is a pixel signal processor for processing pixel signals including the adjustment pixel signal Sig outputted from the solid-state image pickup element 11.

The pixel signal processor 12 comprises: a CDS (Correlated Double Sampling) circuit 13 for finding differences between the black level of pixels and pixel signals; a GCA (Gain Control Amplifier) circuit 14 as an amplifier capable of controlling the gain amount; an ADC (Analog-to-Digital Converter) circuit 15 for converting analog signals to digital signals; a DSP (Digital Signal Processor) 16 for processing the pixel signals being converted to digital signals; an amplitude detection part 17 for detecting the amplitude of the adjustment pixel signal Sig extracted from the DSP 16; a sensor drive circuit 18 for generating drive signals for the solid-state image sensor 11; an initialization level adjusting part 19 for variably adjusting the initialization level V0_{L} of the common power supply voltage V0 in the solid-state image sensor 11 in accordance with the amplitude of the adjustment pixel signal Sig detected by the amplitude detection part 17; and a signal mixing part 20 for mixing the initialization level with the drive signal and supplying it to the solid-state image sensor 11.

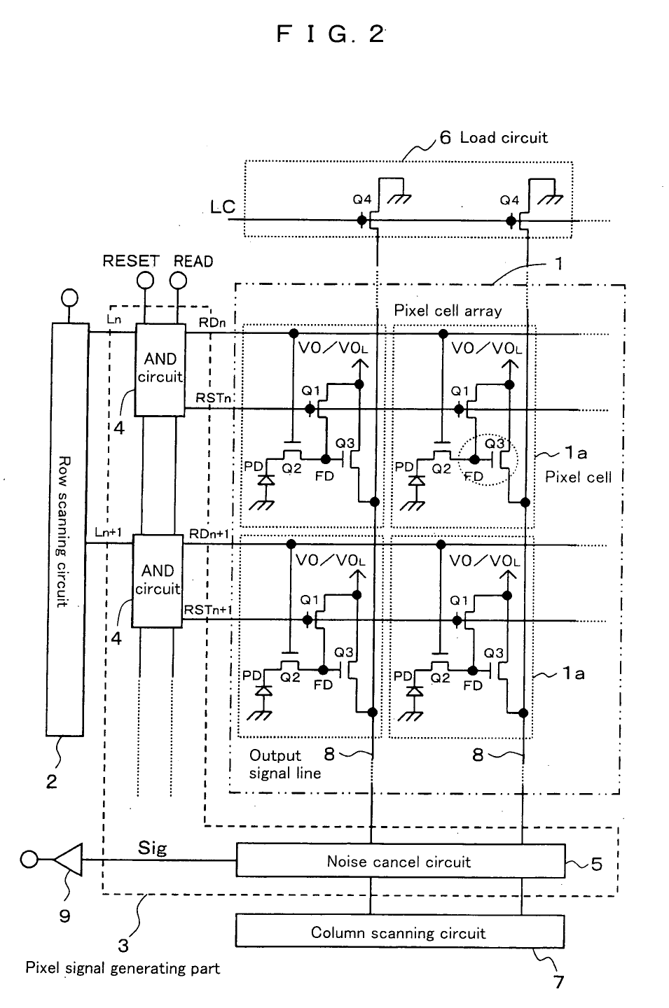

FIG. 2 is a circuit block diagram showing the specific structure of the solid-state image sensor 11. In FIG. 2, reference numeral 1 indicates a pixel cell array constituted with a matrix of pixel cells 1a in L rows×M columns, 2 is a row scanning circuit (row scanning part) which selects a group of pixel cells as much as one row in the pixel cell array 1 in order by a row unit, 3 is a pixel signal generating part that also functions as an adjustment pixel signal generating part, 6 is a load circuit, 7 is a column scanning circuit, 8 is a signal output line, and 9 is an output amplifier. The pixel signal generating part 3 comprises an AND circuit 4 and a noise cancel circuit 5.

The row scanning circuit 2 generates row selecting signals Ln and Ln+1 for selecting the pixel cell group 1a as much as one row in the pixel cell array 1 in order, and outputs those signals to the AND circuit 4 in the pixel signal generating part (adjustment pixel signal generating part) 3.

The AND circuit 4 generates reset pulses RSTn, RSTn+1 based on the logic products of the main reset pulse and the row selecting signals Ln, Ln+1 and outputs those pulses to the pixel cell 1a (specifically, the reset gate Q1) of the selected row. At the same time, the AND circuit 4 generates transfer pulses RDn, RDn+1 based on the logic products of the main transfer pulse READ, which is slightly delayed from the main reset pulse RESET, and the selecting signals Ln, Ln+1, and outputs those to the pixel cell 1a (specifically, the transfer gate Q2) of the selected row.

The noise cancel circuit 5 finds the differences between the output voltage of the output signal line 8 at the time of reset and the output voltage of the output signal line 8 at the time of electric charge transfer as the adjustment pixel signals Sig, and outputs those to the output amplifier 9 in order.

The pixel signal generating part (adjustment pixel signal generating part) 3 inactivates the pixel cell 1a (the output transistor Q3 through electrically connecting the reset gate Q1) to be in an unselected state, after resetting the common power supply voltage V0 to the initialization level V0_{L} in a horizontal blanking period. This initialization level V0_{L} is sufficiently low compared to the common power supply voltage V0 and, in the present invention, the initialization level V0_{L} is variably controlled in accordance with the amplitudes of the adjustment pixel signals Sig.

The column scanning circuit 7 selects a plurality of output signal lines 8 in the pixel cell array 1 one by one in order.

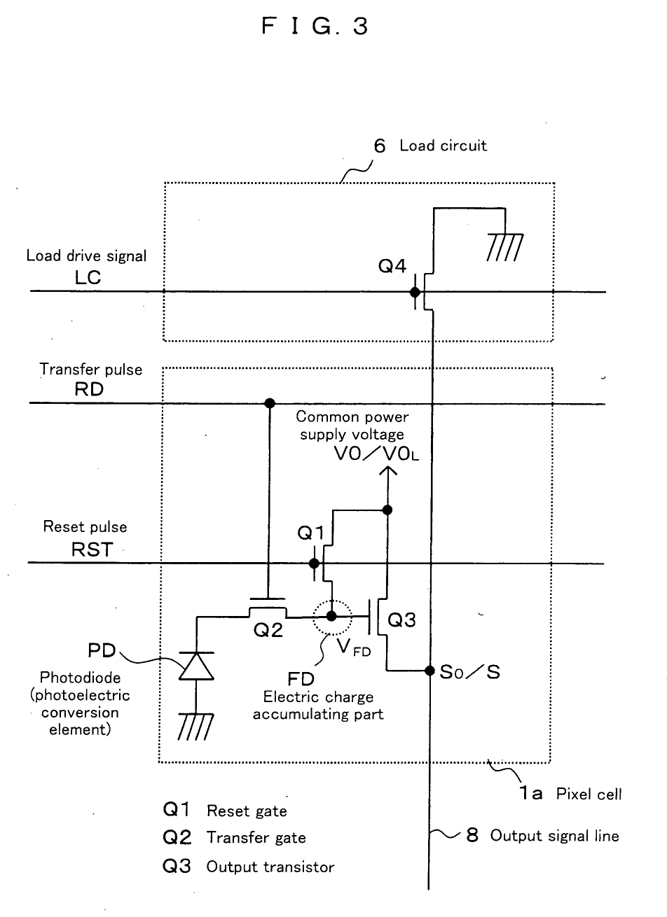

FIG. 3 is a circuit diagram showing the structure of the pixel cell 1a. In FIG. 3, PD indicates a photodiode as a photoelectric conversion element, Q1 is a reset gate, Q2 is a transfer gate, Q3 is an output transistor, and V0 is a common power supply voltage (prescribed voltage). The reset gate Q1, the transfer gate Q2, and the output transistor Q3 are constituted with N-channel type MOS transistors. The anode of the photodiode PD is earthed and the cathode is connected to the source of the transfer gate Q2. A transfer pulse RD from the AND circuit 4 is inputted to the gate of the transfer gate Q2. The drain of the transfer gate Q2 is connected to the common power supply voltage V0 via the reset gate Q1, while being connected to the gate of the output transistor Q3. The connection point of the gate of the output transistor Q3, the reset gate Q1, and the transfer gate Q2 becomes the electric charge accumulating part FD. The reset pulse RST is inputted to the gate of the reset gate Q1 from the AND circuit 4. The drain of the output transistor Q3 is connected to the common power supply voltage V0, and the source thereof is connected to the output signal line 8.

As described above, the pixel cell 1a comprises the reset gate Q1 that performs a supply control (control of connection/separation) of the common power supply voltage V0 to the electric charge accumulating part FD, the transfer gate Q2 that performs a supply control (control of connection/separation) of the electric charge signals to the electric charge accumulating part FD, and the output transistor Q3 whose output voltage is adjusted in accordance with the accumulated voltage of the electric charge accumulating part FD. The pixel cell array 1 comprises such pixels cells 1a being arranged in matrix.

The load circuit 6 comprises a load transistor Q4 inserted between the output signal line 8 and the ground, and the load transistor Q4 is controlled by a load drive signal LC.

Each pixel cell 1a is selected in order by each row in accordance with the row selection signals Ln and Ln+1 from the row scanning circuit 2, and the signals are transmitted to the noise cancel circuit 5 through the output signal line 8. The pixel signals as much as one row (referred to as the adjustment pixel signals Sig) generated in the noise cancel circuit 5 are outputted by one row through the scanning pulse from the column scanning circuit 7, and outputted to the pixel signal processor 12 after they are amplified in the output amplifier 9.

Now, the action of the pixel cell 1a will be described. It is assumed that the transfer gate Q2 is in an off state. When the reset gate Q1 is turned on by the reset pulse RST, the common power supply voltage V0 at “H”-level is applied to the electric charge accumulating part FD. The voltage V_{FD} in the electric charge accumulating part FD determines the amplification factor of the output transistor Q3. The output transistor Q3 outputs the electric current in accordance with the voltage V_{FD} in the electric charge accumulating part FD, and a first output voltage S₀ in which the voltage drop in the load transistor Q4 of the load circuit 6 is taken into account is outputted to the noise cancel circuit 5 from the output signal line 8. Then, the reset gate Q1 is set off. The voltage V_{FD} in the electric charge accumulating part FD in that state becomes the reference potential.

Meanwhile, the photodiode PD accumulates the electric charge (electron) in accordance with the received light amount during a period where the transfer gate Q2 is off. When the transfer gate Q2 is turned on, the accumulated electric charges in the photodiode PD flow into the electric charge accumulating part FD so as to drop the voltage V_{FD} in the electric charge accumulating part FD. As a result, a second output voltage S outputted from the transistor Q3 to the noise cancel circuit 5 via the output signal line 8 drops as well. The second output voltage S is sampled and held in the noise cancel circuit. Then, the transfer gate Q2 is set off, and the photodiode PD restarts the accumulating action of the electrons in accordance with the received light amount. The noise cancel circuit 5 calculates the difference of the electric potentials between the above-described two points as an adjustment pixel signal Sig (=S₀−S). In this adjustment pixel signal Sig, variations in the threshold values of the output transistor Q3 and the noise component thereof are cancelled.

The electric charge accumulating part FD is merely a connection point on the circuit diagram. However, it corresponds to a PN junction in an integrated circuit, which can be formed with a capacitor capable of accumulating a certain amount of electric charges.

As described above, the pixel signal generating part (adjustment pixel signal generating part) 3 carries out the following action in a group of pixel cells 1a as much as one row that is selected by the row scanning circuit 2, in association with the AND circuit 4 and the noise cancel circuit 5. That is, the pixel signal generating part (adjustment pixel signal generating part) 3 detects the first output voltage SO of the output transistor Q3 under the state where the common power supply voltage V₀ is applied to the electric charge accumulating part FD by electrically connecting the reset gate Q1 while cutting off the transfer gate Q2. Further, the pixel signal generating part (adjustment pixel signal generating part) 3 detects the second output voltage S of the output transistor Q3 under the state where the electric charge signals are transferred from the photodiode PD to the electric charge accumulating part FD by electrically connecting the transfer gate Q2 while cutting off the reset gate Q1. After carrying out the above-described detections of the voltages, the pixel signal generating part (adjustment pixel signal generating part) 3 generates the difference between the first output voltage S₀ and the second output voltage S as the adjustment pixel signal Sig. Furthermore, the pixel signal generating part (adjustment pixel signal generating part) 3 resets the common power supply voltage V0 to the initialization level V0_{L} in a horizontal blanking period, and inactivates the output transistor Q3 to be in an unselected state by electrically connecting the reset gate Q1.

As a result, the amplitude detection part 17 detects the amplitudes of the adjustment pixel signals Sig which are outputted from the noise cancel circuit 5 of the pixel signal generating part (adjustment pixel signal generating part) 3. That is, the signal digitalized in the ADC circuit 15 are extracted by the DSP circuit 16, and the initialization level V0_{L} is determined in the amplitude detection part 17 so that the signal amplitude becomes the maximum. According to this, the saturating signal output level that is read out from the solid-state image sensor 11 becomes the maximum.

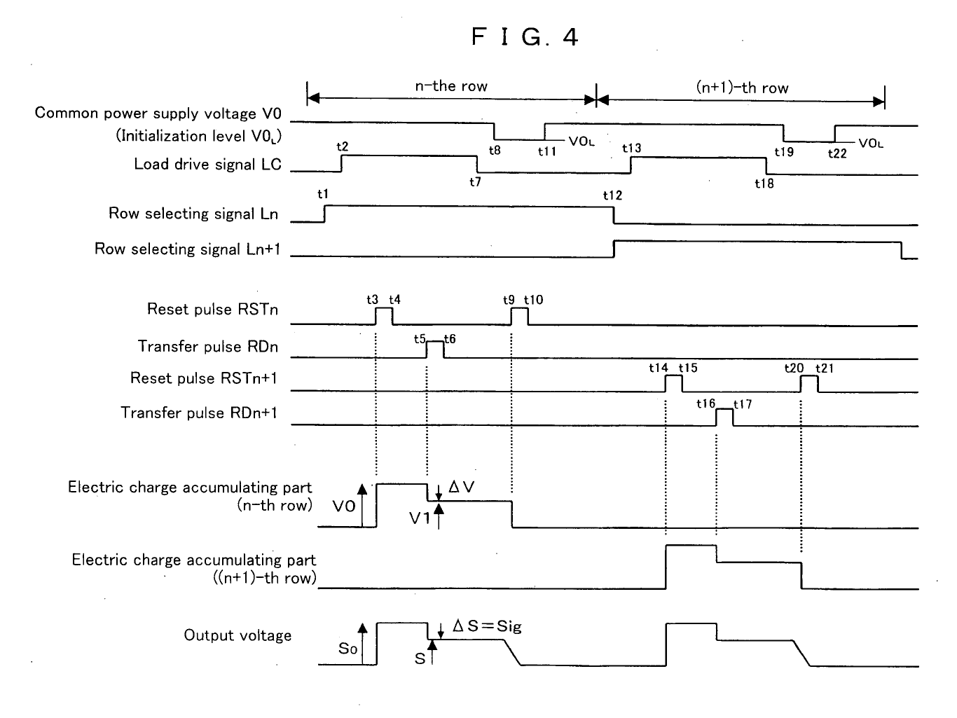

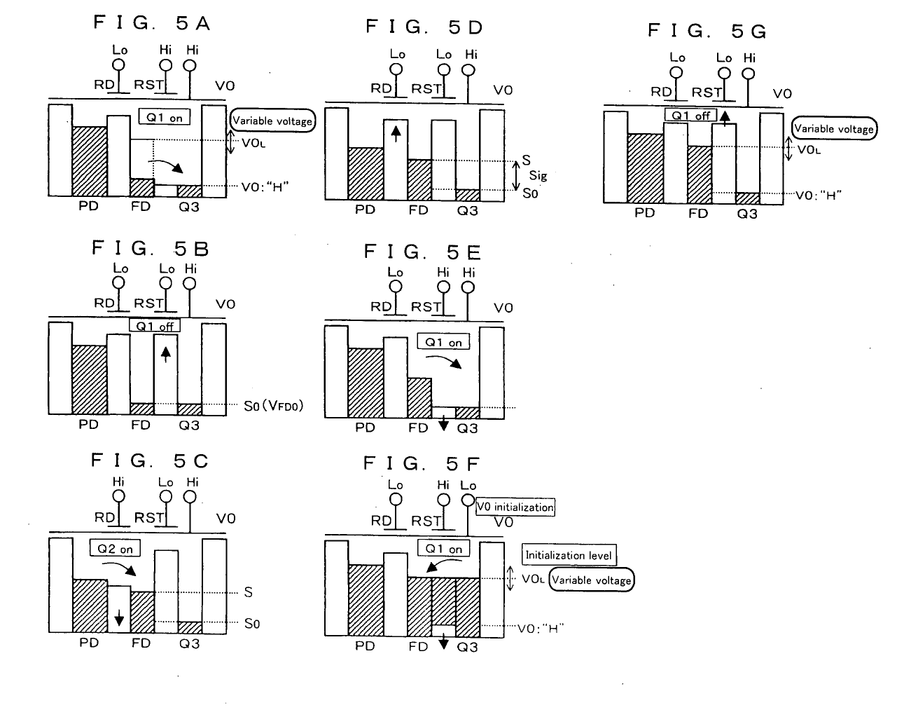

Next, actions of the imaging device according to the embodiment that is constituted in the manner described above will be described referring to the timing chart shown in FIG. 4 and the illustrations of transition in the electric potential shown in FIG. 5 for illustrating the actions at the time of reading out the adjustment pixel signal. FIG. 4 shows the actions of the pixel cell 1a in the n-th row and the pixel cell 1a in the (n+1)-th row. The action of the pixel cell 1a in the n-th row will be described here in detail.

At a time t1, when the row-selecting signal Ln in n-th row from the row scanning circuit 2 becomes active, a group of the pixel cells 1a in the n-th row in the pixel cell array 1 is selected.

Then, at a time t2, the load drive signal LC is set active, the load transistor Q4 in the load circuit 6 becomes on, and the output signal line 8 is activated.

Subsequently, at a time t3, the main reset pulse RESET is set active, the reset pulse RSTn is outputted from the AND circuit 4 to the group of pixel cell cells 1a in the n-th line, and the reset gate Q1 in the pixel cell 1a is turned on. The common power supply voltage V0 is adjusted in advance, and the adjusted common power supply voltage V0 is applied to the electric charge accumulating part FD when the reset gate Q1 becomes on (see FIG. 5). The output transistor Q3 having the adjusted common power supply voltage V0 applied to its gate outputs the electric current in accordance with the common power supply voltage V0, and the output voltage to which the voltage drop in the load transistor Q4 of the load circuit 6 is taken into account is inputted to the noise cancel circuit 5 from the output signal line 8.

Then, at a time t4, the reset pulse RSTn becomes inactive, and the reset gate Q1 becomes off. At this time, the adjusted common power supply voltage V0 is held in the electric charge accumulating part FD (see FIG. 5B). The adjusted common power supply voltage V0 becomes the reference potential level V_{FD0}. At this time, the output voltage outputted from the output signal line 8 to the noise cancel circuit 5 is the first output voltage S₀.

Then, at a time t5, the main transfer pulse READ is set active, the transfer pulse RDn is outputted from the AND circuit 4 to the group of the pixel cells 1a in the n-th row, and the transfer gate Q2 in the pixel cell 1a becomes on. As a result, the cathode of the photodiode PD is connected to the electric charge accumulating part FD, and the optical information electric charges accumulated in the photodiode PD are read out to the electric charge accumulating part FD. That is, as the optical information electric charges are minus, the electric potential of the electric charge accumulating part FD drops. In accordance with the electric potential drop ΔV in the electric charge accumulating part FD, the output electric potential of the output transistor Q3, i.e. the electric potential of the output signal line 8 drops as well (see FIG. 5C). This potential drop amount ΔS corresponds to the accumulated electric charges (received light amount) of the photodiode PD.

Then, at a time t6, when the transfer pulse RDn becomes inactive, the transfer gate Q2 is turned off and the electric potential of the electric charge accumulating part FD is held at V1 (=V0−ΔV) (see FIG. 5D). At this time, the output voltage outputted from the output signal line 8 to the noise cancel circuit 5 is the second output voltage S. The photodiode PD restarts the electric charge accumulation in accordance with the optical information.

Subsequently, between the time t6 and a time t7, the noise cancel circuit 5 calculates the electric potential difference ΔS (=S₀−S) of the output signal line 8 as the adjustment pixel signal Sig. This calculation of the adjustment pixel signal Sig is performed simultaneously for the group of all the pixel cells 1a in the n-th row.

Then, at a time t7, the load drive signal LC becomes inactive, and the output signal line 8 becomes inactivated. A horizontal blanking period starts from the time t7.

Then, at a time t8, the common power supply voltage V0 is dropped to the initialization level V0_{L} by the initialization processing. This initialization level V0_{L} is generated in the following manner. The amplitude detection part 17 detects the electric potential that corresponds to the adjustment pixel signal Sig, and the initialization level adjusting part 19 generates the initialization level V0_{L} according to the detected electric potential. The signal mixing part 20 mixes the initialization level V0_{L} with the various drive signals from the sensor drive circuit 18 and supplies it to the solid-state image sensor 11.

Subsequently, at a time t9, the reset pulse RSTn is set active again, and the reset gate Q1 is turned on. The common power supply voltage V0 is dropped in advance to the initialization level V0_{L} of “L”-level, and the gate of the output transistor Q3 becomes “L”-level in accordance with the turning on of the reset gate Q1. Thus, the output transistor Q3 is turned off (see FIG. 5E and FIG. 5F).

Then, at a time t10, the reset pulse RSTn becomes inactive, and the reset gate Q1 is set off.

Further, at a time t11, the initialization level V0_{L} from the signal mixing part 20 is applied to the solid-state image sensor 11 (see FIG. 5G). As a result, the electric potential in the electric charge accumulating part FD is held at the initialization level V0_{L}.

Through the above processing, the output action of the adjustment pixel signals Sig in accordance with the received light amount of the pixel cells 1a arranged in the n-th row is completed. After that, at a time t12, the row selecting signal Ln becomes the “L”-level, and the n-th row becomes an unselected row. At the same time, the row-selecting signal Ln+1 becomes the “H”-level, and the (n+1)-th row becomes the selected row. The actions of the pixel cells 1a in the (n+1)-th row from time t12 to time t22 are the same as the actions of the pixel cells 1a in the n-th row from time t1 to time t11.

As described above, it is possible according to the embodiment to maximize the saturating output signal level of the pixel cells 1a through optimizing the initialization level V0_{L} of the common power supply voltage V0 that drives the pixel cells 1a, in accordance with the amplitude of the adjustment pixel signal Sig.

Further, the amplitude detection part 17 detects the amplitude of the adjustment pixel signal Sig before picking up images. The initialization level adjusting part 19 also carries out the adjustment of initialization level of the predetermined voltage before picking up images. Therefore, the saturating amplitude of the pixel signal can be adjusted without affecting the actual filming.

In the solid-state image sensor 11, the group of pixel cells 1a having the above-described functions can be provided as a group of dummy pixel cells in a region with no pixels, which is outside the area of L rows×M columns. There is no pixel in the dummy pixel region, however, the same pulse drive as described above is performed therein. The dummy pixel region can output signals that are not affected by a dark current of the electric charge accumulating part FD. Such signals are outputted in the horizontal blanking period and vertical blanking period.

If it is constituted so that, through utilizing the group of dummy pixel cells, the electric charge accumulating part of the dummy pixel cell group is always set under an unselected state even during an action of picking up images, the amplitudes of the adjustment pixel signals Sig obtained therefrom are detected, and the initialization level of the common power supply voltage is adjusted in accordance with the detected amplitudes, it becomes possible to maximize the saturating amplitudes of the pixel signals through dynamically optimizing the electric charge amount held in the electric charge accumulating part, even when there are changes in the environmental conditions such as temperatures and power supply voltages.

The present invention has been described in detail referring to the most preferred embodiments. However, various combinations and modifications of the components are possible without departing from the spirit and the broad scope of the appended claims.

What is claimed is:

1. An imaging device, comprising
a plurality of pixel cells which generate electric charge signals by photoelectric conversion and then accumulate said electric charge signals,
an adjustment pixel signal generating part for generating adjustment pixel signals based on said electric charge signals,
an amplitude detection part, and
an initialization level adjusting part, wherein:
said adjustment pixel signal generating part generates difference between first output voltages of said pixel cells where a prescribed voltage is applied and accumulated, and second output voltages of said pixel cells where said electric charge signals are accumulated, as said adjustment pixel signals;
said amplitude detection part detects amplitudes of said adjustment pixel signals; and
said initialization level adjusting part adjusts an initialization level of said prescribed voltage in accordance with a result of amplitude detection performed by said amplitude detection part.

2. The imaging device according to claim 1, wherein said initialization level adjusting part adjusts said initialization level of said prescribed voltage so that amplitudes of said adjustment pixel signals become maximum.

3. The imaging device according to claim 1, wherein:
said pixel cells are arranged in matrix to constitute a pixel cell array;
said imaging device further comprises a row scanning part which selects a group of pixel cells of one row in said pixel cell array in order by a row unit; and
said adjustment pixel signal generating part generates said adjustment pixel signals by a unit of said group of pixels of one row that is selected by said row scanning part.

4. The imaging device according to claim 1, wherein, said pixel cells comprise, respectively:
a photoelectric conversion element for generating said electric charge signals by photoelectric conversion;
an electric charge accumulating part for accumulating said electric charge signals;
a reset gate for performing a supply control of said prescribed voltage to said electric charge accumulating pat;
a transfer gate for performing a supply control of said electric charge signals to said electric charge accumulating part; and
an output transistor whose output voltage is adjusted in accordance with a voltage accumulated in said electric charge accumulating part, wherein:
said first output voltage are output voltage of said output transistor under a state where said prescribed voltage is applied to said electric charge accumulating part by cutting off said transfer gate and electrically connecting said reset gate; and
said second output voltage are output voltage of said output transistor under a state where said electric charge signals are transferred to said electric charge accumulating part by cutting off said reset gate and electrically connecting said transfer gate.

5. The imaging device according to claim 4, wherein, in a horizontal blanking period, said adjustment pixel signal generating part sets said common power supply voltage to an initialization level and sets said output transistor to be under an unselected state.

6. The imaging device according to claim 4, wherein said adjustment pixel signal generating part electrically connects said reset gate and simultaneously set said output transistor to be under an unselected state.

7. The imaging device according to claim 4, wherein:
said amplitude detection part detects amplitudes of said adjustment pixel signals before picking up images; and
said initialization level adjusting part adjusts said initialization level of said prescribed voltage before picking up images.

8. The imaging device according to claim 1, further comprising, separately from said pixel cells, dummy pixel cells having an electric charge accumulating part that is always under an unselected state during an action of picking up images, wherein
said adjustment pixel signal generating part generates difference between first output voltages of said dummy pixel cells where a prescribed voltage is applied and accumulated, and second output voltages of said dummy pixel cells where said electric charge signals are accumulated, as said adjustment pixel signals.

9. The imaging device according to claim 1, wherein said prescribed voltage is a common power supply voltage of said imaging device.
